(19) United States
(12) Patent Application Publication
(10) Pub. No.: US 2016/0125077 A1
(43) Pub. Date: May 5, 2016

(54) MUSIC RECOMMENDATION SYSTEM FOR VEHICLE AND METHOD THEREOF

(71) Applicant: Hyundai Motor Company, Seoul (KR)

(72) Inventors: Woochul Jung, Seoul (KR); Young Woo Choi, Incheon (KR)

(21) Appl. No.: 14/746,966

(22) Filed: Jun. 23, 2015

(30) Foreign Application Priority Data
Oct. 29, 2014 (KR) 10-2014-0148301

(51) Int. Cl. G06F 17/30

(52) U.S. Cl. CPC G06F 17/30761; G06F 17/30752; G06F 17/30339

(57) ABSTRACT

An automotive music recommendation system includes: a communication unit that receives a music list including music content from a portable audio device by communicating with the portable audio device; an information detection unit that detects driving condition information when music content included in the music list is played or when a user of a vehicle requests a music recommendation; a music management unit that creates a matching table by matching the music list with the driving condition information upon playing the music content; and a music recommendation unit that, when receiving a music recommendation request from the user, creates a recommendation list by extracting music content from the matching table based on the driving condition information upon receiving the music recommendation request.

### CROSS-REFERENCE TO RELATED APPLICATION

This application claims priority to and the benefit of Korean Patent Application No. 10-2014-0148301 filed in the Korean Intellectual Property Office on Oct. 29, 2014, the entire contents of which are incorporated herein by reference.

### BACKGROUND OF THE DISCLOSURE

(a) Technical Field

The present disclosure relates generally to an automotive music recommendation system, and more particularly, to an automotive music recommendation system for recommending and providing at least one piece of music on the basis of driving condition information and a list of music to which a driver has listened, and a method thereof.

(b) Description of the Related Art

Drivers or passengers of vehicles can listen to music or radio broadcasting using an audio system installed therein. Vehicle audio systems often include an external audio connector for connecting portable audio devices, such as a portable cassette player, a CD player, an MP3 player, and/or a mobile communication device. A portable audio device may be connected to the vehicle audio system through an external audio connector or local wireless communication, and music is then provided from the portable audio device and outputted through speakers.

When a driver or passenger stores music in a portable audio device, the vehicle sequentially plays the music through the vehicle audio system. Further, music available through an application installed in a portable audio device can be sequentially played by the vehicle audio system.

Since drivers conventionally have been required to manually operate the portable audio device in order to listen to music while driving, their eyes are diverted from the road, thereby increasing the risk of traffic accidents occurring. Accordingly, drivers face difficulty in listening to music that is preferable, while using safe driving techniques.

The above information disclosed in this Background section is only for enhancement of understanding of the background of the disclosure, and therefore, it may contain information that does not form the related art that is already known in this country to a person of ordinary skill in the art.

### SUMMARY OF THE DISCLOSURE

The present disclosure has been made in an effort to provide an automotive music recommendation system and method having advantages of being able to recommend music in view of weather, a season, a road type, a traffic condition, and time based on a music list of a driver. Further, the present disclosure has been made in an effort to provide an automotive music recommendation system and method having advantages of being capable of matching and keeping the information on driving conditions and music that a driver has listened to, and of recommending music under the same situation later.

According to embodiments of the present disclosure, an automotive music recommendation system includes: a communication unit that receives a music list including music content from a portable audio device by communicating with the portable audio device; an information detection unit that detects driving condition information when music content included in the music list is played or when a user of a vehicle requests a music recommendation; a music management unit that creates a matching table by matching the music list with the driving condition information upon playing the music content; and a music recommendation unit that, when receiving a music recommendation request from the user, creates a recommendation list by extracting music content from the matching table based on the driving condition information upon receiving the music recommendation request.

The music recommendation unit may extract driving condition information upon playing the music content that is the same as the driving condition information upon receiving the music recommendation request, extracts at least one music content matched with the driving condition information upon playing the music content from the matching table, and creates a recommendation list containing the at least one extracted music content. The music recommendation unit may search at least one related music content similar to physical characteristic information of the at least one extracted music content and creates the recommendation list such that the recommendation list includes the at least one searched related music content and the extracted music content.

The music management unit may extract music meta-information from the music list and creates the matching table by matching the driving condition information upon playing the music content with the music meta-information.

The music meta-information may include at least one of: music identification information, a music title, a genre, a singer's name, album information, and lyric information.

The system may further include a speaker that outputs the music content included in the music list or the recommendation list.

The driving condition information may include at least one of: weather condition information, time information, road type information, season information, and vehicle mode information.

Furthermore, according to embodiments of the present disclosure, an automotive music recommendation method includes: playing music content included in a music list set by a user of a vehicle; detecting driving condition information when the music content is played; creating a matching table by matching the music content with the driving condition information upon playing the music content; receiving a music recommendation request from the user; detecting driving condition information when the music recommendation request is received; and creating a recommendation list by extracting music content from the matching table based on the driving condition information upon receiving the music recommendation request.

The creating of the matching table may include: creating the matching table by matching the driving condition information upon playing the music content with music meta-information of the music content.

The music meta-information may include at least one of: music identification information, a music title, a genre, a singer's name, album information, and lyric information.

The playing of the music content may include: vconnecting a portable audio device to the vehicle; and vplaying the music content in the music list set through a music application of the portable audio device.

The method may further include: playing the music content; extracting the driving condition information upon playing the music content that is the same as the driving condition information upon receiving the music recommendation request from the matching table; extracting music content matched with the driving condition information upon playing the music content; creating a recommendation list including the extracted music content; and playing music content included in the recommendation list.

The driving situation information may include at least one of: weather information, time information, road type information, season information, and vehicle mode information.

Furthermore, according to embodiments of the present disclosure, an automotive music recommendation method includes: connecting a portable audio device to a vehicle; creating a matching table by matching driving condition information with music content that is listened to through the portable audio device; receiving a music recommendation request from a user of the vehicle; detecting driving condition information when the music recommendation request is received; extracting music content matched with the driving condition information from the matching table upon receiving the music recommendation request; creating a recommendation list containing the music content; and playing music content included in the recommendation list.

The creating of therecommendation list may include: searching at least one related music content similar to the music content extracted from the music content; and creating the recommendation list including the at least one searched related music content and the extracted music content.

The searching of the at least one related music content may include: checking physical characteristic information of the extracted music content; and searching the at least one related music content similar to the physical characteristic information of the extracted music content.

In view of the above, a driver and/or passenger of a vehicle can listen to music that he/she likes in accordance with driving conditions, because the system recommends music in view of the weather, the season, the road condition, the vehicle condition, and time. Further, safe driving habits can be encouraged since a driver can listen to music based on the driving conditions even without directly operating a portable audio device while driving.

Other effects that can be obtained or expected from embodiments of the present disclosure are directly or suggestively described in the following detailed description. That is, various effects expected from embodiments of the present disclosure will be described in the following detailed description.

### BRIEF DESCRIPTION OF THE DRAWINGS

FIG. 1 is a schematic diagram illustrating an automotive music recommendation system according to embodiments of the present disclosure.

FIG. 2 is a flowchart illustrating an automotive music recommendation method according to embodiments of the present disclosure.

FIG. 3 is a diagram illustrating a method of creating a matching table according to embodiments of the present disclosure.

FIG. 4 is a diagram illustrating a method of creating a recommendation list according to embodiments of the present disclosure.

### DETAILED DESCRIPTION OF THE EMBODIMENTS

The operation principle of an automotive music recommendation system and method according to embodiments of the present disclosure will be described hereafter in detail with reference to the accompanying drawings. However, the drawings to be described below and the following detailed description relate to one preferred exemplary embodiment of various embodiments for effectively explaining the characteristics of the present disclosure. Therefore, the present disclosure should not be construed as being limited to the drawings and the following description.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

Further, in the description of the present disclosure, the detailed description of related well-known configurations and functions is not provided, when it is determined as unnecessarily making the scope of the present disclosure unclear. The terminologies to be described below are ones defined in consideration of their function in the present disclosure, and may be changed by the intention of a user or an operator or a custom. Therefore, their definition should be determined on the basis of the description of the present disclosure.

Further, in the following embodiments, the terminologies are appropriately changed, combined, or divided so that those skilled in the art can clearly understand them, in order to efficiently explain the main technical characteristics of the present disclosure, but the present disclosure is not limited thereto.

Hereinafter, exemplary embodiments of the present disclosure will be described in detail with reference to the accompanying drawings.

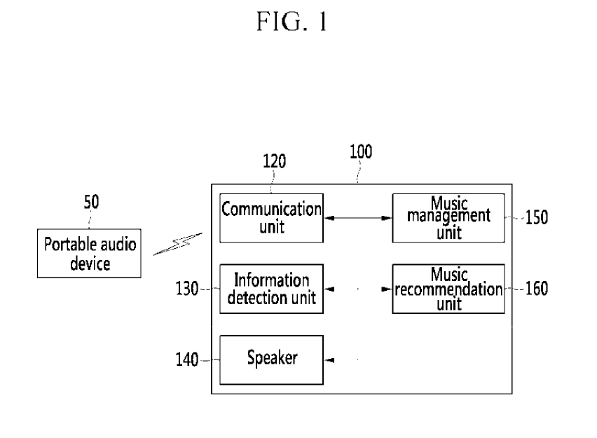

FIG. 1 is a schematic diagram illustrating an automotive music recommendation system according to embodiments of the present disclosure.

Referring to FIG. 1, an automotive music recommendation system 100 is connected with a portable audio device 50.

The portable audio device 50 sets and transmits music lists to the automotive music recommendation system 100. In detail, when a user (i.e., driver or passenger) selects a music application of a plurality of applications installed on the portable audio device 50, the portable audio device 50 recognizes and then executes the music application selected by the driver. When a driver (or passenger) selects at least one music content (e.g., songs) through the installed music application, the portable audio device 50 creates a music list containing the music content. The music list may contain music meta-information on at least one music content. The music meta-information may contain at least one of music identification information, a music title, a genre, a singer's name, album information, and lyric information. The music identification information may be information allowing for recognizing music content. The album information, which is the information about an album containing music contents, may contain the information about album publication dates, album titles, and album title songs.

The portable audio device 50 is connected to the automotive music recommendation system 100 and transmits music lists to the automotive music recommendation system 100. When a driver plays a music list through a music application, the portable audio device 50 can transmit the music list to the automotive music recommendation system 100. The portable audio device 50 can be replaced by any types of devices, as long as they can set music lists through a music application. For example, the portable audio device 50 may be any one of a mobile communication terminal, a mobile computer such as a tablet PC, a notebook, and a netbook, and a navigation system.

The automotive music recommendation system 100 includes a communication unit 120, an information detection unit 130, a speaker 140, a music management unit 150, and a music recommendation unit 160. The communication unit 120 communicates with the portable audio device 50. That is, the communication unit 120 can wirelessly communicate with the portable audio device 50 through local wireless communication. The local wireless communication may be any one of Bluetooth, IrDA (Infrared Data Association, WiFi, Wireless LAN, RF (Radio Frequency), NFC (Near Field Communication), ZigBee, and the like. Further, the communication unit 120 may be connected with the portable audio device 50 by a wire to communicate with it, through an audio terminal in a vehicle. The communication unit 120 receives music lists from the portable audio device 50 through wire or wireless communication.

The information detection unit 130 detects driving condition information. The information detection unit 130 detects the driving condition information when music included in a music list is played or when the communication unit 120 receives a music list from the portable audio device 50. The driving condition information means information about situations when a vehicle is running. For example, the driving condition information may include at least one of weather information, time information, traffic situation information, road type information, season information, and vehicle mode information. The weather information may show the weather while a vehicle runs, and may be expressed as ‘rain’, ‘snow’, and ‘clear’. The time information, which show time when a vehicle runs, may be expressed as a going-to-work time and leaving-the-office time or may show the exact time such as 7 AM or 2 PM. The traffic situation information may show the traffic situation around a vehicle that is running, such as ‘congested’, ‘smooth’, and ‘normal’. The road type information may show the type of road on which a vehicle is running, such as a highway, a common road, and a state road. The season information may show the season in which a vehicle is running, such as spring, summer, fall, and winter. The vehicle mode information may show driving modes of a vehicle such as a sports mode and a normal mode.

When receiving a request for recommending music from a driver, the information detection unit 130 detects the driving condition information at that point of time.

The speaker 140 outputs music contents (e.g., songs). That is, when a music list is received or the portable audio device 50 plays a music list, the speaker 140 outputs (i.e., plays) at least one music content in the music list. Further, the speaker 140 outputs at least one music content in a recommendation list created by the music recommendation unit 160.

The music management unit 150 creates and manages a matching table obtained by matching music contents according to the driving condition around vehicle. In detail, the music management unit 150 creates a matching table by matching driving condition information at the point of playing time (i.e., upon playing the music content) with music content received through the communication unit 120. That is, the music management unit 150 creates a matching table by matching the driving condition information at the point of playing time with the music meta-information of at least one music content in a music list. When only music identification information of music meta-information is contained in a music list, the music management unit 150 may create a matching table by checking the music meta-information on the basis of the music identification information in the music list and then matching driving condition information with the music meta-information.

The music recommendation unit 160 creates a recommendation list by extracting music contents corresponding to the driving condition information when a driver requests music. In detail, when receiving a request for recommending music from a driver, the music recommendation unit 160 receives the driving condition information at the point of recommendation time (i.e., upon receiving the music recommendation request) from the information detection unit 130. The music recommendation unit 160 extracts driving condition information at the point of playing time which is the same as the driving condition information at the point of recommendation time from the matching table. The music recommendation unit 160 checks at least one piece of music meta-information matched with the driving condition information at the point of playing time.

The music recommendation unit 160 checks music contents on the basis of the music meta-information and creates a recommendation list containing at least one music content. The music recommendation unit 160 controls the speaker 140 so that the created recommendation list can be output through the speaker 140.

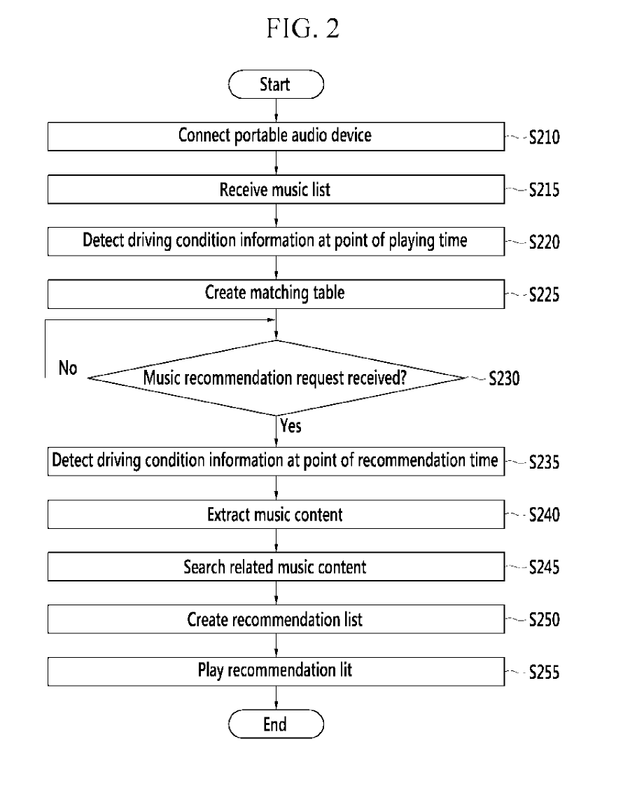

FIG. 2 is a flowchart illustrating an automotive music recommendation method according to embodiments of the present disclosure. The components of the automotive music recommendation system 100 according to an exemplary embodiment of the present disclosure described above with reference to FIG. 1 may be integrated or subdivided, so it should be understood that components capable of those functions described above can be the components of the automotive music recommendation system 100 according to embodiments of the present disclosure, irrespective of the names. An automotive music recommendation method according to embodiments of the present disclosure is described hereafter under the assumption that the main body in each step is not the corresponding component, but the automotive music recommendation system 100.

Referring to FIG. 2, the automotive music recommendation system 100 is connected with the portable audio device 50 (S210). That is, the automotive music recommendation system 100 may be connected with the portable audio device 50 by a wire through an audio connector or may be wirelessly connected with the portable audio device 50 through local wireless communication.

The automotive music recommendation system 100 receives a music list from the portable audio device 50 (S215). In other words, when a driver plays a music list through a music application in the portable audio device 50, the portable audio device 50 transmits the music list to the automotive music recommendation system 100. The automotive music recommendation system 100 receives the music list from the portable audio device 50 and outputs the music contents played by the portable audio device 50 through the speaker 140.

When a driver send a request for playing a music content through the automotive music recommendation system 100, the automotive music recommendation system 100 requests music lists from the portable audio device 50 and receives music lists kept in the portable audio device 50 from the portable audio device 50. The automotive music recommendation system 100 may play at least one music content on the basis of the music lists.

The automotive music recommendation system 100 detects the driving condition information at the point of time when the music content is played (S220). That is, at the point of playing time (i.e., upon playing the music content), the automotive music recommendation system 100 detects driving condition information including at least one of weather information, time information, traffic situation information, road type information, season information, and vehicle mode information, which show the situation when a vehicle is running.

The automotive music recommendation system 100 creates a matching table by matching the music content with the information about the situation when the vehicle is running at the point of time when the music content is played (S225). In other words, the automotive music recommendation system 100 creates a matching table by matching the music meta-information of at least one music content in the music lists with the driving condition information at the point of playing time.

The automotive music recommendation system 100 determines whether a music recommendation request from a driver has been received (S230). When a request for recommending music from a driver has not been received, the automotive music recommendation system 100 returns to step S230 and determines whether the driver has input a music recommendation request.

When a music recommendation request from a driver has been received, the automotive music recommendation system 100 detects the driving condition information at the point of time when the driver has requested music (S235) (i.e., upon receiving the music recommendation request).

The automotive music recommendation system 100 extracts at least one music content for the driving condition at the point of recommendation time, using the matching table (S240). In detail, the automotive music recommendation system 100 checks the driving condition information at the point of playing time (i.e., upon playing the music content) which is the same as the driving condition information at the point of recommendation time (i.e., upon receiving the music recommendation request) from the matching table, and extracts a music content matched with the driving condition information at the point of playing time from the matching table.

The automotive music recommendation system 100 searches related music contents similar to the music content (S245). In other words, the automotive music recommendation system 100 checks physical characteristic information of at least one music content extracted in step S240. The physical characteristic information may be the information about physical characteristics such as the pitch and the beat of music contents. The automotive music recommendation system 100 searches related music contents similar to the physical characteristic information of the music content extracted from music contents that can be listened to through the music application in the potable audio device 50.

The automotive music recommendation system 100 creates a recommendation list for recommending a music content, which corresponds to the current situation when a vehicle is running, to the driver (S250). That is, the automotive music recommendation system 100 creates a recommendation list containing at least one of the music contents extracted in step S240 and the related music contents extracted in step S245.

The automotive music recommendation system 100 plays the recommendation list created in step S250 (S255). Therefore, the automotive music recommendation system 100 according to embodiments of the present disclosure can manage music contents by matching driving condition information with music contents, which are set in advance by a driver, and when the driver sends a music recommendation request later, the system can recommend music contents by extracting the music contents matched with the driving condition information at the point of recommendation time in the music contents that the driver has listened to before.

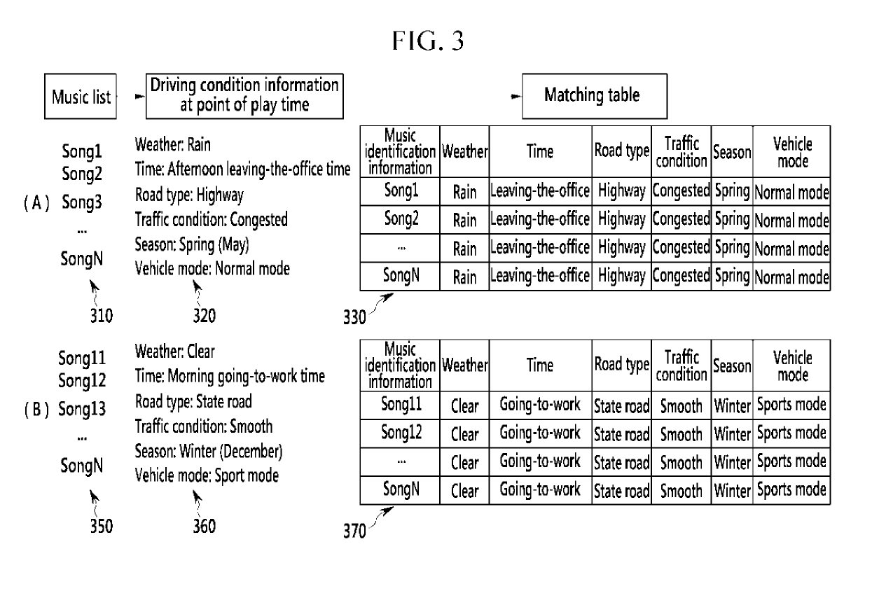

FIG. 3 is a diagram illustrating a method of creating a matching table according to embodiments of the present disclosure.

Referring to (A) of FIG. 3, a driver sets a first music list 310 through a music application in the portable audio device 50. Thereafter, when the driver plays the first music list 310, the automotive music recommendation system 100 detects the driving condition information 320 at the point of playing time that contains rain, afternoon leaving-the-office time, a highway, congestion, spring (May), and a common mode. Further, the automotive music recommendation system 100 creates a first matching table 330 by matching the driving condition information 320 at the point of playing time with the music contents in the first music list 310.

Referring to (B) of FIG. 3, when a driver plays a second music list 350 kept in the portable audio device 50, the automotive music recommendation system 100 detects the driving condition information 360 at the point of playing time that contains clear, morning going-to-work time, a state road, smoothness, winter (December), and a sports mode. Further, the automotive music recommendation system 100 creates a second matching table 370 by matching the driving condition information 360 at the point of playing time with the music contents in the second music list 350.

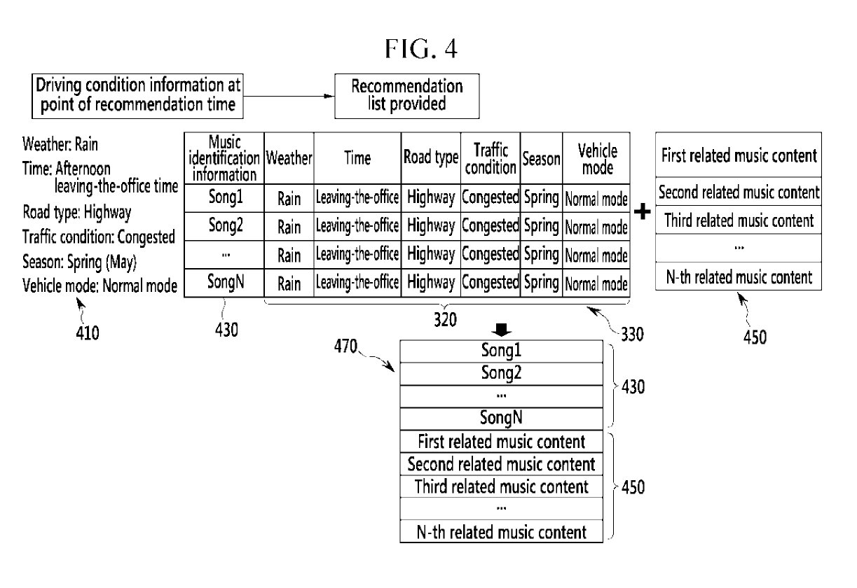

FIG. 4 is a diagram illustrating a method of creating a recommendation list according to embodiments of the present disclosure.

Referring to FIG. 4, when the driver requests music recommendation, the automotive music recommendation system 100 detects the driving condition information 410 at the point of recommendation time that contains rain, afternoon leaving-the-office time, a highway, congestion, spring (May), and a common mode. The automotive music recommendation system 100 checks the driving condition information 320 at the point of playing time that is the same as the driving condition information 410 at the point of recommendation time and extracts music contents 430 matched with the driving condition information at the point of playing time, from the first matching table and the second matching table 370, which are created in FIG. 3.

The automotive music recommendation system 100 searches related music contents 450 similar to the physical characteristic information of the extracted music contents 430. The automotive music recommendation system 100 creates a recommendation list 470 containing the extracted music contents 430 and the searched related music contents 450. Thereafter, the automotive music recommendation system 100 can play and provide the created recommendation list 470 to a driver.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

50: Portable audio device
100: Automotive music recommendation system
120: Communication unit
130: Information detection unit
140: Speaker
150: Music management unit
160: Music recommendation unit

What is claimed is:

1. An automotive music recommendation system comprising:
a communication unit that receives a music list including music content from a portable audio device by communicating with the portable audio device;
an information detection unit that detects driving condition information when music content included in the music list is played or when a user of a vehicle requests a music recommendation;
a music management unit that creates a matching table by matching the music list with the driving condition information upon playing the music content; and
a music recommendation unit that, when receiving a music recommendation request from the user, creates a recommendation list by extracting music content from the matching table based on the driving condition information upon receiving the music recommendation request.

2. The system of claim 1, wherein the music recommendation unit extracts driving condition information upon playing the music content that is the same as the driving condition information upon receiving the music recommendation request, extracts at least one music content matched with the driving condition information upon playing the music content from the matching table, and creates a recommendation list containing the at least one extracted music content.

3. The system of claim 2, wherein the music recommendation unit searches at least one related music content similar to physical characteristic information of the at least one extracted music content and creates the recommendation list such that the recommendation list includes the at least one searched related music content and the extracted music content.

4. The system of claim 1, wherein the music management unit extracts music meta-information from the music list and creates the matching table by matching the driving condition information upon playing the music content with the music meta-information.

5. The system of claim 4, wherein the music meta-information includes at least one of: music identification information, a music title, a genre, a singer's name, album information, and lyric information.

6. The system of claim 1, further comprising:
a speaker that outputs the music content included in the music list or the recommendation list.

7. The system of claim 1, wherein the driving condition information includes at least one of: weather information, time information, road type information, season information, and vehicle mode information.

8. An automotive music recommendation method comprising:
playing music content included in a music list set by a user of a vehicle;
detecting driving condition information when the music content is played;
creating a matching table by matching the music content with the driving condition information upon playing the music content;
receiving a music recommendation request from the user;
detecting driving condition information when the music recommendation request is received; and
creating a recommendation list by extracting music content from the matching table based on the driving condition information upon receiving the music recommendation request.

9. The method of claim 8, wherein the creating of the matching table comprises:
creating the matching table by matching the driving condition information upon playing the music content with music meta-information of the music content.

10. The method of claim 9, wherein the music meta-information includes at least one of: music identification information, a music title, a genre, a singer's name, album information, and lyric information.

11. The method of claim 8, wherein the playing of the music content comprises:
connecting a portable audio device to the vehicle; and
playing the music content in the music list set through a music application of the portable audio device.

12. The method of claim 8, comprising:
playing the music content;
extracting the driving condition information upon playing the music content that is the same as the driving condition information upon receiving the music recommendation request from the matching table;
extracting music content matched with the driving condition information upon playing the music content;
creating a recommendation list including the extracted music content; and
playing music content included in the recommendation list.

13. The method of claim 8, wherein the driving situation information includes at least one of: weather information, time information, road type information, season information, and vehicle mode information.

14. An automotive music recommendation method comprising:
connecting a portable audio device to a vehicle;
creating a matching table by matching driving condition information with music content that is listened to through the portable audio device;
receiving a music recommendation request from a user of the vehicle;
detecting driving condition information when the music recommendation request is received;
extracting music content matched with the driving condition information from the matching table upon receiving the music recommendation request;
creating a recommendation list containing the music content; and
playing music content included in the recommendation list.

15. The method of claim 14, wherein the creating of therecommendation list comprises:
searching at least one related music content similar to the music content extracted from the music content; and
creating the recommendation list including the at least one searched related music content and the extracted music content.

16. The method of claim 15, wherein the searching of the at least one related music content comprises:
checking physical characteristic information of the extracted music content; and
searching the at least one related music content similar to the physical characteristic information of the extracted music content.
